(19) United States
(12) Patent Application Publication
(10) Pub. No.: US 2015/0242827 A1
(43) Pub. Date: Aug. 27, 2015

(54) SYSTEM AND METHOD FOR FACILITATING SPACE TRANSACTIONS

(71) Applicants: Lin GUO, Los Altos, CA (US); Jon Y. Ikegami, Los Altos, CA (US)

(72) Inventors: Lin GUO, Los Altos, CA (US); Jon Y. Ikegami, Los Altos, CA (US)

(21) Appl. No.: 14/628,009

(22) Filed: Feb. 20, 2015

Related U.S. Application Data
(60) Provisional application No. 61/943,179, filed on Feb. 21, 2014.

(51) Int. Cl. G06Q 20/14; G06Q 50/30

(52) U.S. Cl. CPC G06Q 20/145; G06Q 50/30

(57) ABSTRACT

A computer-implemented method of facilitating a transaction for a physical space includes specifying, in a digital computer, one or more criteria for identifying transitory physical spaces that can be occupied; receiving, at the digital computer, information describing one or more of the spaces that satisfy the one or more criteria; transmitting an identification of a selected space from among the described one or more spaces; and receiving, at the digital computer, contact information associated with the selected space.

This application is a non-provisional application of U.S. Provisional Patent Application No. 61/943,179 filed on Feb. 21, 2014, which is hereby incorporated by reference in its entirety.

### BACKGROUND

Contemporary life often requires people to occupy transitory physical spaces in the course of accomplishing various tasks. For example, people must often stand in waiting lines, which can be considered to be made up of transitory physical spaces, each of which disappears once the front of the line is reached. A problem with waiting lines is that they often require one to be physically present in the line—otherwise, one's spot in line will be taken by someone else. People are thus forced to wait in lines, which is both inconvenient and takes away from time that could be spent on more important or more valuable activities.

As another example, parking a vehicle often requires drivers to actually go to the physical location of the space and conduct a transaction in person. This can be both inconvenient and time-consuming. Additionally, one cannot be guaranteed that a space is available, potentially leading to unexpectedly long searches that can lead to undesired delays.

Conversely, many other people are available to occupy these transitory physical spaces in place of others. There is, however, currently no viable mechanism by which these two parties can be matched up.

### SUMMARY

Embodiments of the invention can be implemented in numerous ways, including as a method and as an apparatus.

In one embodiment, a computer-implemented method of facilitating a transaction for a physical space comprises: specifying, in a digital computer, one or more criteria for identifying transitory physical spaces that can be occupied; receiving, at the digital computer, information describing one or more of the spaces that satisfy the one or more criteria; transmitting an identification of a selected space from among the described one or more spaces; and receiving, at the digital computer, contact information associated with the selected space.

The space may be a parking space, or a position in a queue.

The one or more criteria may include at least one of a price, a date, a time, a size, a text-based description, and a number of spaces.

The information describing one or more of the spaces may further comprise price information for the one or more of the spaces.

The one or more criteria may include a location identifier, and the spaces that satisfy the one or more criteria may be within a predetermined distance from a location represented by the location identifier.

In another embodiment, a computer-implemented method of facilitating a transaction for a physical space comprises: specifying, in a digital computer, one or more criteria for identifying parties interested in one or more transitory physical spaces that can be occupied; receiving, at the digital computer, information describing one or more of the parties that satisfy the one or more criteria; transmitting an identification of a selected party from among the described one or more parties; and receiving, at the digital computer, contact information for the selected space.

In yet another embodiment, a computer-implemented method of facilitating transactions of particular spaces comprises: receiving, from a plurality of first digital computing devices representing a plurality of first users, information describing a plurality of transitory physical spaces that can be occupied; receiving, from the plurality of first digital computing devices, one or more first criteria by which to identify parties potentially interested in the plurality of transitory physical spaces; receiving, from a plurality of second digital computing devices representing a plurality of second users, one or more second criteria by which to identify transitory physical spaces of interest; transmitting to the plurality of first digital computing devices information describing those second users that meet the one or more first criteria; and transmitting to the plurality of second digital computing devices information describing those physical spaces that meet the one or more second criteria.

The one or more first criteria may include desired prices for the plurality of transitory physical spaces. The method may further comprise receiving updates to the desired prices, and transmitting to the plurality of second digital computing devices the updates to the desired prices.

The one or more second criteria may include prices the second users are willing to pay for the plurality of transitory physical spaces. The method may further comprise receiving updates to the prices the second users are willing to pay, and transmitting to the plurality of first digital computing devices the updates to the prices the second users are willing to pay.

The method may further comprise: receiving, from the plurality of second digital computing devices, selections from among those physical spaces that meet the one or more second criteria; and transmitting to the plurality of second digital computing devices contact information associated with the selections.

In a further embodiment, a computer-implemented method of facilitating a transaction for a physical space comprises: receiving a request for a space, the request transmitted from a second digital computing device, wherein the request includes one or more criteria by which a space is to be selected, the one or more criteria including a location identifier; identifying, from among the plurality of spaces, those spaces having locations within a predetermined distance from a location represented by the location identifier, and that satisfy the remaining one or more criteria besides the location identifier, so as to identify a set of spaces; transmitting information describing the identified set of spaces to the second digital computing device; receiving, from the second digital computing device, a selected space from among the identified set of spaces; and transmitting, to the second digital computing device, contact information associated with the selected space.

In a still further embodiment, an apparatus comprises: a system of one or more digital computers in electronic communication with each other, the one or more digital computers programmed to provide a medium for facilitating transactions of transitory physical spaces that can be occupied, by: allowing users to enter specified criteria defining the transitory physical spaces; transmitting, to first ones of those users seeking one or more of the transitory physical spaces, information on those transitory physical spaces that meet their specified criteria; and transmitting, to second ones of those users owning or occupying one or more of the transitory physical spaces, information describing the first ones of those users that meet the specified criteria of the second ones of those users.

In a yet further embodiment, a method of facilitating transactions for goods and/or services comprises: receiving, from a first set of users, first price information corresponding to prices that the first set of users are willing to pay for predetermined goods and/or services; receiving, from a second set of users, second price information corresponding to prices that the second set of users request in return for the goods and/or services; transmitting the second price information to the first set of users, so as to form transmitted second price information; transmitting the first price information to the second set of users, so as to form transmitted first price information; receiving updated ones of the first price information and the second price information from the first and second sets of users; and updating the transmitted first and second price information in substantial real time as the updated ones of the first and second price information are received, so as to provide to both the first and the second set of users a substantially real time view of one or more market prices for the goods and/or services.

In a still further embodiment, a method of facilitating the making of parking reservations in one or more parking lots comprises: receiving a request to reserve a parking space for a vehicle in a parking lot substantially immediately upon a confirmation of the request, the request further being for a reserved space for the vehicle in exchange for a fee to be determined on a per-time basis, for an indeterminate time period; confirming reservation of space in the parking lot; and setting a beginning of the time period to be a time occurring substantially immediately upon the confirming, regardless of whether the vehicle is occupying the reserved space at the confirming.

In a still further embodiment, a method of reserving space in a parking lot comprises: in an application program run on a digital computer, reserving a parking space in a parking lot while being located remote from the parking lot, in exchange for a fee that is determined on a per-time basis, for an indeterminate time period commencing substantially immediately upon the reserving.

In a still further embodiment, a method of reserving space in a parking lot comprises: receiving a request to reserve a parking space for a vehicle; confirming reservation of space in the parking lot; and substantially immediately after the confirming, reserving a parking area for the vehicle regardless of the location of the vehicle, and commencing billing for the vehicle on a per-time basis, for a period of time that is indeterminate at the time of the commencing.

### BRIEF DESCRIPTION OF THE DRAWINGS

For a better understanding of the disclosure, reference is made in the following detailed description to the accompanying drawings, in which:

FIG. 1 illustrates an exemplary computer-based system for implementing embodiments of the present invention.

FIG. 2 conceptually illustrates further details of a server for implementing embodiments of the present invention.

FIG. 3 is a flowchart illustrating steps taken by space sellers when using an application program consistent with embodiments of the present invention.

FIG. 4 is a flowchart illustrating steps taken by space buyers when using an application program consistent with embodiments of the present invention.

FIG. 5 conceptually illustrates steps taken by a server implementing embodiments of the present invention.

Like reference numerals refer to corresponding parts throughout the drawings.

### DETAILED DESCRIPTION OF EMBODIMENTS OF THE INVENTION

As described above, the occupation of transitory physical spaces often results in wasted time. People who are forced to occupy a particular physical spot must take time to do so, which takes time away from other more valuable activities. Others are available to take up these spots in their stead, which would save time. Those who would be otherwise forced to wait in a line can simply pay these others to wait in line, and can arrive and take their place when approaching the head of the line. Unfortunately, no good mechanism exists for matching these two parties.

Embodiments of the present invention provide a solution to this problem, by providing a platform that automatically matches these parties in substantial real time. Those who do not wish to spend their time waiting in a line, or searching for a space, can simply enter their desired space criteria, e.g. prices, availability times, and the like, and spaces meeting these criteria are automatically presented. Simultaneously, those occupying a space, or willing to occupy one, can enter their desired criteria, e.g. locations, times, and prices others are willing to pay for a space, and users that meet these criteria are automatically presented. In this manner, embodiments of the invention provide a convenient online marketplace that allows those occupying a space, or willing to occupy one, to see potential customers, and those seeking spaces to see available spaces for sale. The information can be updated continuously, allowing users to revise their spaces, the amounts they are willing to pay, or the amounts they are seeking for their spaces, continuously, with each party seeing these updates.

The establishment of such an online marketplace allows for numerous advantages. For example, overall societal efficiency is increased. People will no longer be required to stand in line for very long, freeing them up to pursue activities more valuable to them. Similarly, people with free time can spend it waiting in line on behalf of others, allowing them to receive compensation for doing so, and thus providing them an opportunity to generate income where otherwise no such opportunity previously existed.

Embodiments of the invention provide a platform by which these people can find each other and transact for spaces. Users can simply enter a desired location on their mobile device, and view available spaces at or near that location, along with other criteria such as prices, availability times, and the like. One of these spaces can be selected, whereupon a transaction can be made for that space. The system employed can be a server-based system that handles the transaction, or simply transmits contact information to the involved parties (i.e. the space seller and space buyer/renter), and allows them to complete a transaction themselves. In this manner, any space can be reserved remotely and immediately via a computer or mobile device, without need to actually be present at the space.

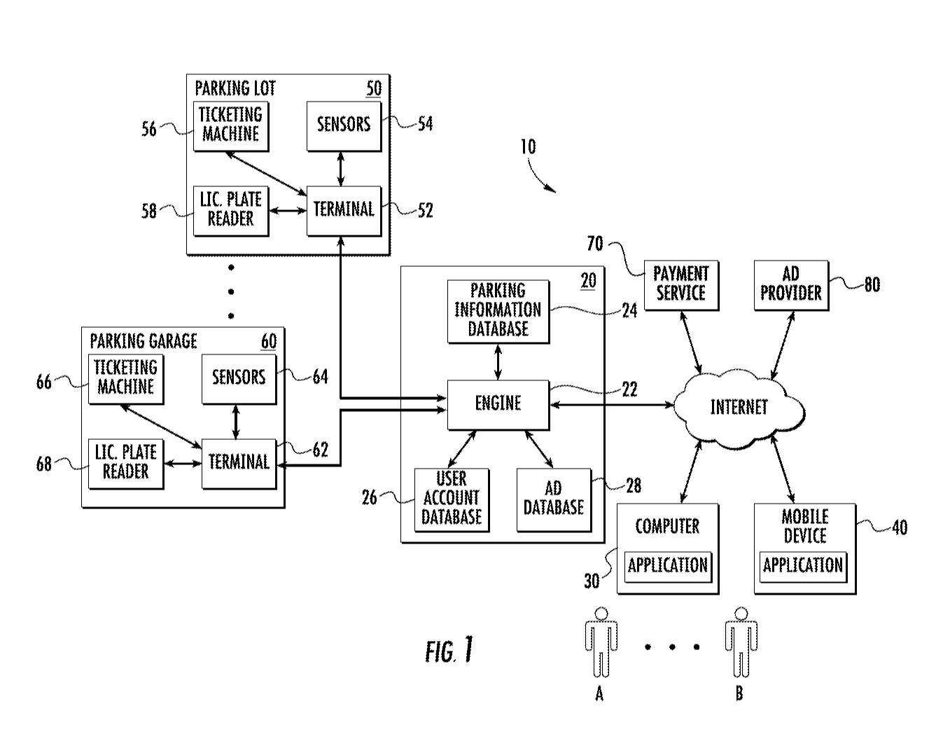

FIG. 1 illustrates an exemplary system for implementing embodiments of the present invention. In FIG. 1, system 10 includes a server 20 connected to the Internet or other computer-based communications network, along with any number of computers 30 and mobile computers 40 operated by users such as users A and B. The computers 30 can be desktop computers or any other computational device capable of communicating with server 20, and the mobile devices 40 can be any mobile computational devices such as smartphones, tablet computers, laptops, or the like. Each of the computers 30 and mobile computers 40 can run one or more application programs for interfacing and communicating with the server 20. The system 10 also includes any number of parking lot systems 50 and/or parking garage systems 60, each of which is a computational system controlling various functions at a parking lot or garage (though not necessarily entirely located at that lot or garage). Also included can be a payment service 70 for processing payments, and an ad provider 80.

The server 20 includes an engine or processor 22, a parking information database 24, a user account database 26, and an ad database 28. The various databases can exist as separate databases, or may be combined in any manner. That is, one or more databases can contain and/or take on the roles of any one or more of these databases 24, 26, 28.

The parking lot systems 50 can include a central terminal 52, and a number of sensors 54, as well as a ticketing machine 56 and license plate reader 58. The sensors 54 can be known sensors located at each stall and indicating whether a stall is vacant, and can also include gate sensors indicating when cars enter/leave the lot. The sensors 54 are in communication with terminal 52, allowing for terminal 52 to keep track of the number and possibly the location of any vacant spaces. The ticketing machine 56 is a known device that issues tickets to vehicles entering the lot, and takes tickets from vehicles leaving the lot. The ticketing machine 56 may be a single machine that both issues and takes in tickets, or may be two separate machines, one for each function. The license plate reader 58 may be a known machine that reads license plates of vehicles entering/exiting the parking lot 50, and transmits this information to terminal 52. This allows the terminal 52 to keep track of the identities of vehicles in the lot, allowing for the parking lot system 50 to keep track of the time each vehicle has spent in the lot, without first issuing it a ticket. Accordingly, a particular lot 50 may (or may not) have only one of the ticketing machines 56 and plate reader 58.

In similar manner, the parking garage systems 60 may each include a central terminal 62, sensors 64, one or more ticketing machines 66, and a license plate reader 68. The sensors 64, ticketing machine 66, and license plate reader 68 may operate, and be configured, similar to the sensors 54, ticketing machine 56, and license plate reader 58 of parking lot 50, as described above.

In operation, users can submit space listings to the server 20, which maintains a database of space listings and their locations. When another user wishes to purchase/rent a space, he/she enters their desired location, and the server 20 sends them a list of spaces, perhaps with their locations shown on an interactive map. The user can then purchase/rent a space. For example, user A can enter a space listing via an application run on their computer 30, where it is transmitted to server 20 and stored in parking information database 24 along with information on any other spaces. When user B enters a desired location via an application on his/her mobile device 40, the server 20 transmits to the application information on all spaces (this information including the stored location of each space) stored in its database 24 that are within a predetermined distance from the desired location. This distance can be entered by user B, or preset within the server 20 or mobile device 40. The space information received by the mobile device 40 can be displayed as icons at specific locations on an interactive map displayed by the mobile device 40.

Once user B sees this interactive map, he/she can select from among the displayed spaces, perhaps by simply touching the corresponding icon. For purposes of illustration, say that the selected space was the space submitted by user A. The user B can optionally then be prompted to enter a payment, to be processed by the payment service 70 in known manner. Once payment is successfully processed, the server 20 sends user B stored contact information for the owner/holder of the selected space. The server 20 may also send user A contact information previously entered (at any point) by user B. The two parties A and B can then contact each other to carry out a transaction for user A's space.

In this manner, the service provided by server 20 allows for users to select a desired location, and to then be presented with a listing of available spaces within a certain distance from that location. The presentation can be map-based (i.e. a real-time interactive map showing available spaces and their locations) or can be any other listing of available spaces. For example, the presentation can simply be a text-based list of spaces, ordered by distance, price, or any other criteria. Similarly, the map-based presentation can show the spaces and their locations, as well as any other desired information, such as their prices, availability times, number of spaces, user rating, and the like. Any such information is contemplated.

Conversely, the server 20 can also show space owners/holders a presentation of users looking for spaces, and their locations. For example, user A, after entering information on his/her space (e.g., location, as well as any other information, which can optionally include any one or more of desired price, number of spaces, dates/times of availability, or the like), may be presented with a listing of space seekers within a certain distance from that location, or their current location. This listing can be map-based (i.e. a real-time interactive map showing current space seekers and their locations) or can be any other listing of space seekers. For example, the presentation can simply be a text-based list of space seekers, ordered by distance, price, rating, or any other criteria. Similarly, the map-based presentation can show current space seekers and their locations, as well as any other desired information, such as their desired or maximum prices, desired times, ratings, and the like. Any such information is contemplated.

In this manner, both space holders and those seeking spaces can be simultaneously presented with interactive, real-time and map-based presentations of potential interested parties, and either one or both can select the other to conduct a space transaction. That is, space holders can be presented with an interactive map-based listing of current buyers/renters near a location of interest, and at the same time, those seeking spaces can also be presented with an interactive map-based listing of available spaces near their location of interest. Selecting one allows the parties to, perhaps after a payment, receive contact information of the other, so that the other party can be contacted and a transaction conducted for the particular space.

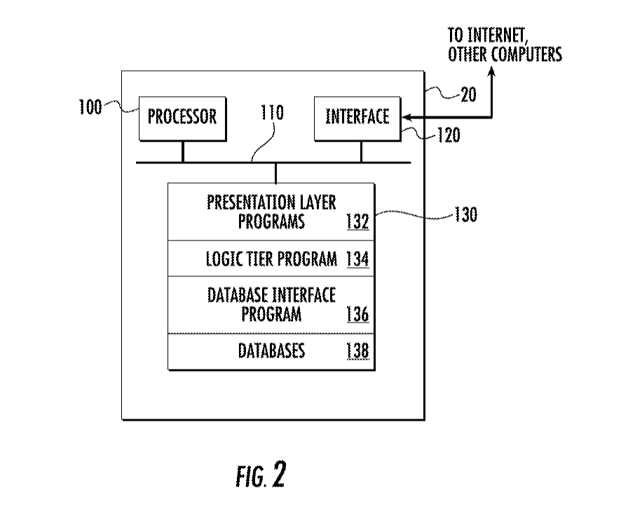

While the server 20 and various other computational devices of FIG. 1 can be constructed in any manner, and contain any programs suitable for operation as above and below, FIG. 2 illustrates further details of one embodiment of server 20. Here, server 20 includes a processor 100, bus 110, interface 120, and memory 130. The processor 100, interface 120, and memory 130 are in communication across bus 110. The processor 100 executes instructions contained in the programs of memory 130, while the interface 120 allows communication with the other computational devices of FIG. 1 via the Internet or other electronic communication medium. The processor 100, interface 120, and programs of the memory 130 which carry out the above and below processes collectively can be thought of as making up the engine 22.

The memory 130 stores a number of programs, including presentation layer programs 132, logic tier programs 134, database interface programs 136, and databases 138. The databases 138 may include any of the databases used to organize and store information used in space transactions, including the above described databases 24, 26, and 28. The database interface programs 136 may include those programs configured to act as an interface for the databases 138 to the logic tier 134, as is known. The logic tier programs 134 are database access layer programs, and access the database interface programs 136 as well as other remote programs (such as mapping, location, etc. programs) to retrieve desired information stored in the databases 138 or store information as appropriate. The logic tier programs 134 transfer information between end user application programs and databases 138, to allow for the transfer of information between the databases 138 and end users as below. The construction of such logic tier programs 134 is known. The presentation layer programs 132 are application programs providing an interface to end users.

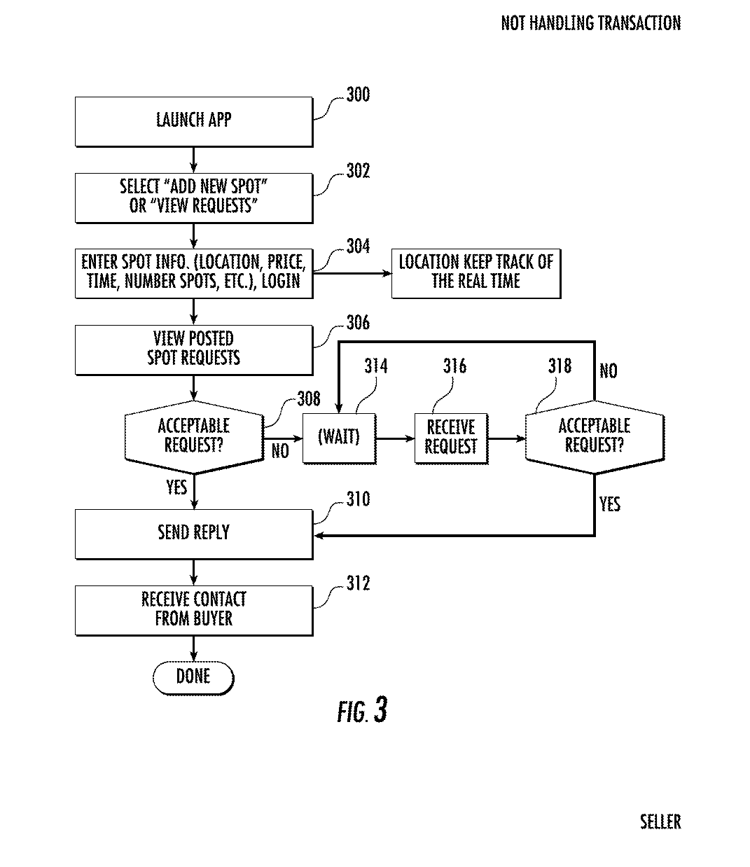

FIG. 3 illustrates further details of the process of submitting a space listing to server 20, and the resulting location-based presentation of information. Continuing with the above examples, once user A decides to list his or her space, he/she launches the appropriate application program (Step 300) on computer 30, whereupon user A can be prompted to, among other things, add a new space listing. Once user A selects this option (Step 302), he or she is prompted to enter information on the space, as well as his/her own location and, perhaps, login information such as a username and password (Step 304). Login information, if required, can be stored in the user account database 26 for verification at future logins. The information includes the location of the space, which will most likely be an address, although any other information is also contemplated. For example, the location information that is allowed to be entered can include text-based descriptions of the space location (e.g., a position in a line, the floor and stall # of a parking space, etc.), GPS coordinates, or any other information that can serve to specify a space location. Other information besides location can also be entered. This information can include any one or more of desired price, availability times or deadlines (after which the space will no longer be available), the number of spaces available, and the like. The application program then transmits this information to server 20 via the Internet, where it can be stored in the parking information database 24 (while the login information may be stored in user account database 26).

Based on user A's entered space location, the engine 22 (and more specifically, one or more logic tier programs 134) can then retrieve information from databases 138 on users seeking a space, whose locations are within some predetermined distance from user A's entered space location. Engine 22 then transmits an identifier for each of these users (e.g., their usernames, or some other more anonymous identifier, such as simply a number or other descriptor) and their locations to the computer 30, whereupon the application program displays this information for user A (Step 306). As above, this display can take any form. In one embodiment, the display can take the form of an interactive map, such as a Google™ map with the current locations of the nearby users seeking a space. That is, the identifier and location information transmitted to the computer 30 can be displayed as icons on an online interactive map. The engine 22 can also transmit other information to computer 30, such as the desired price and times entered by each user seeking a space, all of which is stored in databases 138. This information can also be displayed on the interactive map.

User A then decides whether any of these users seeking spaces are acceptable (Step 308). If so, user A selects one, perhaps by simply clicking on or touching the icon representing that user. User A may then optionally be asked to remit a payment, whereupon the selected user's contact information is sent to computer 30. User A can then contact the selected user. Alternatively, after selecting another user, user A may be prompted to (or the server 20 may automatically) send a reply to the selected buyer (Step 310). User A may then receive contact from the buyer (Step 312), whereupon the two parties may agree upon a transaction for user A's listed space.

If user A decides that no listed/displayed users are acceptable, then user A may wait (Step 314) until he/she receives a request from another user (Step 316), where this request can include any information or criteria that this other user decides to submit, such as their price, etc. This information can also include a rating, if the user has a history. User A must then decide whether this other user is acceptable to do business with, or if the request is otherwise acceptable (Step 318). If so, the process goes to Step 310 or otherwise allows the parties to contact each other and complete a transaction for the space. If the request is not acceptable, user A denies the request and returns to Step 314, waiting to receive another request.

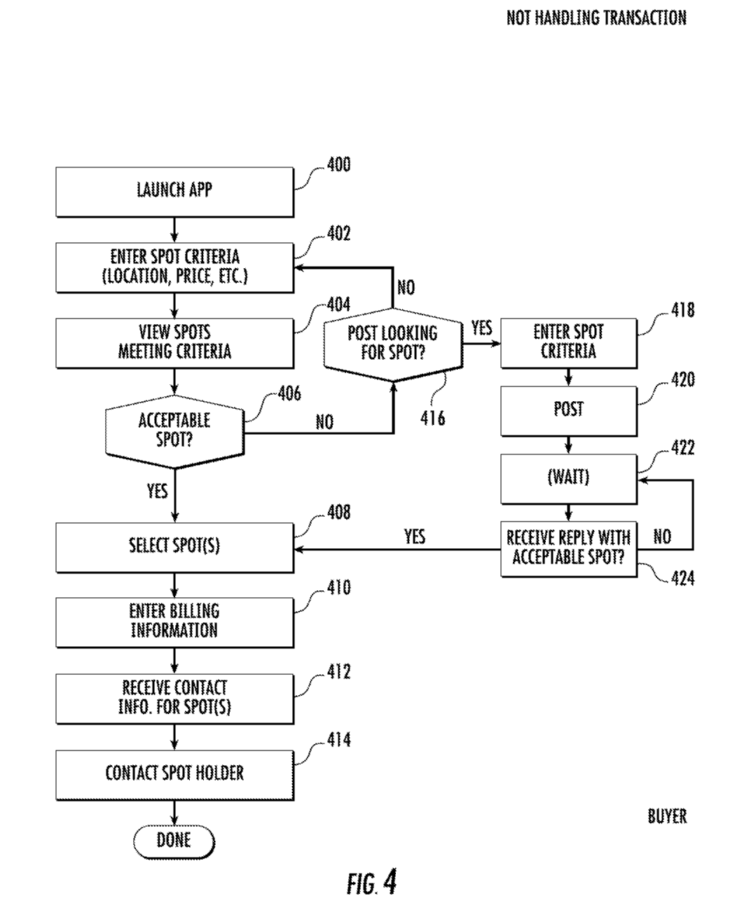

FIG. 4 illustrates further details of the process of searching for and purchasing a space. Consider user B to be interested in purchasing/renting a space. User B would first launch the appropriate application on his or her mobile device 40 (Step 400), and could then enter their space criteria (Step 402). The criteria can be any criteria, and would include location information, as well as any one or more of any suitable criteria, such as price, number of spaces, time or time periods, etc. The application would transmit these criteria, along with possibly login information if user B is required to log in, to server 20, which as above then retrieves space listings satisfying user B's entered criteria and transmits them back to the application. The application then displays these listings for user B (Step 404). As above, these listings can be displayed in any form, for example as an interactive map showing the retrieved space listings as icons, as a simple text listing of the retrieved spaces, or any other method of displaying such information.

User B can then view the retrieved listings and decide whether one is acceptable (Step 408). For listings displayed on a touch screen-based device such as a smartphone with a touch screen interface, user B can touch various listings to view more information and/or select them. If upon viewing the space's information, one is acceptable, user B can select a space (Step 408) and enter his or her billing information if a fee is charged for the service (Step 410), perhaps after entering login information. If no fee is to be charged for the service, Step 410 can be omitted.

As described previously, the space selection is transmitted back to server 20, and billing, if any, is processed by payment service 70. Upon completion of billing (if any), the server 20 retrieves contact information for the owner of the selected space listing, and transmits it to the mobile device 40, where it is displayed on the application for user B to view (Step 412). User B can then contact the space holder directly (Step 414) and the two parties can complete their transaction for the listed space.

If, at Step 406, user B does not find an acceptable space from amongst the retrieved listings, the application may allow user B to post that he or she is looking for a space (Step 416). If user B decides not to post, the process can return to Step 402, allowing user B to conduct another search for spaces, perhaps with different criteria. Alternatively, if user B decides to submit a post, he or she is allowed to enter their space criteria (Step 418), or the application may auto-populate fields of the post with the criteria that user B already entered at Step 402. User B can also optionally enter other information, such as a message further explaining what type of space he/she is looking for. The application transmits these criteria and information to the server 20, which then sends the post to various users, such as user A described above, who may have their applications open and thus be searching for a buyer for their space (Step 422). Any of these users can then send a reply to user B via server 20 if they are interested in selling their space to user B, whereupon user B receives the reply at his or her mobile device 40 (Step 424). The process can then return to step 408, allowing user B to select the space that is the subject of the reply if he or she is interested. If no reply is received, the process instead returns to Step 422, and user B continues to wait for a reply.

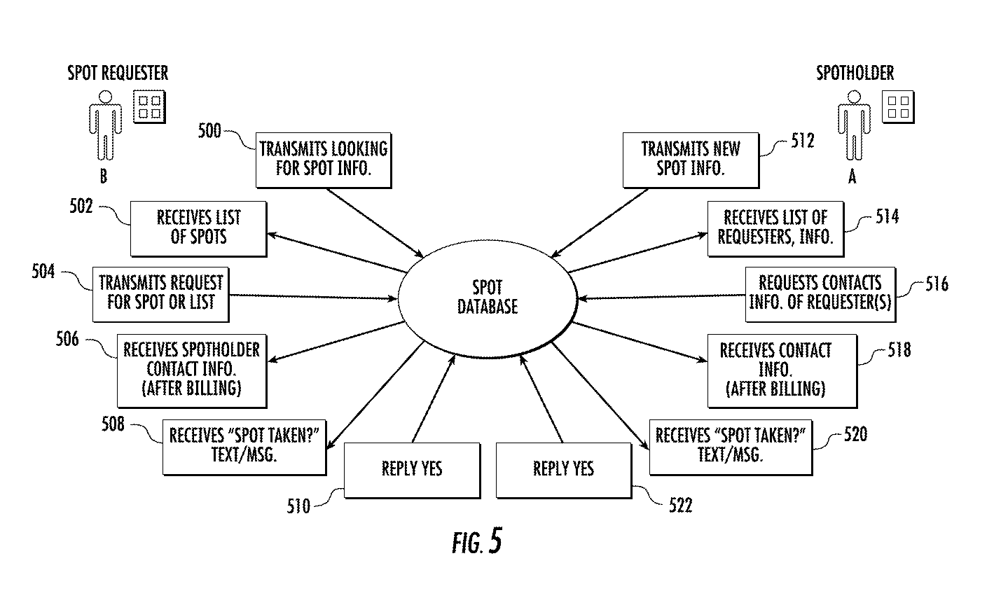

FIG. 5 illustrates further details of the above described processes, from the point of view of server 20. In operation, the server 20 simultaneously transmits to, and receives listings from, a number of different users. In particular, the server 20 can receive new listings from users, as well as transmit listings and user information to those same users or to others. The left side of FIG. 5 illustrates processes undertaken in conjunction with users such as user B, who are spot requesters, and the right side of FIG. 5 illustrates processes undertaken in conjunction with users such as user A, who are spot holders/renters.

For those interested in spaces, e.g. user B, a request for spaces that meet specified criteria is transmitted to server 20 (Step 500), whereupon a logic tier program 134 of server 20 retrieves those spaces that meet these specified criteria, compiles them into a list, and sends the list to the requester (Step 502). User B can then select a particular spot from this list, where the server 20 is informed of the selection (Step 504). The server 20 then can optionally initiate a billing process, or simply send user B the stored contact information of the holder of the selected space (Step 506). User B can then contact the space holder and complete a transaction for the space. Later, server 20 can send a message in any form (text, query in application, email, etc.) asking user B whether the space is taken, i.e. whether user B successfully transacted for the space (Step 508), to which user B can reply yes (Step 510). A yes reply can cause the server 20 to flag that space listing as taken, so that the listing is withdrawn from other users' lists, or marked as taken.

For those interested in selling/renting their spaces, or in potentially occupying a space for subsequent transaction, e.g. user A, a new space listing is entered, or a request to view space requesters is sent to server 20, along with the criteria desired by user A (Step 512). One or more logic tier programs 134 of server 20 then retrieves a list of those space requesters that meet these specified criteria, compiles them into a list, and sends the list to user A's application (Step 514). User A can then select one of these space requesters through their application, and request their contact information (Step 516). The server 20 then can optionally initiate a billing process, or simply send user A the stored contact information of the space requester (Step 518). User A can then contact the space requester to conduct a transaction for the space. Later, server 20 can send a message in any form (text, query in application, email, etc.) asking user A whether the space is taken, i.e. whether user A successfully transacted for the space (Step 520), to which user A can reply yes (Step 522). A yes reply can cause the server 20 to flag that space listing as taken, so that the listing is withdrawn from other users' lists, or marked as taken.

The server 20 can handle any number of spot requesters and spot holders in the above described manner. That is, any number of spot holders can enter space listings. These listings are stored and maintained by server 20 within one or more of its databases, and can be transmitted to any number of spot requesters. Similarly, any number of spot requesters can enter their information, where it is stored in one or more of the databases of server 20, and listings of spot requesters can be sent to any number of spot holders, or potential spot holders. Information on space listings and spot requesters can be updated at any time, whereupon updates are sent to each appropriate user. In this manner, users can see a real-time list of either spaces they may be interested in, or other users who may be interested in their space.

In the above described manner, server 20 provides a platform for users to transact for reserved spaces. Users can enter space listings, request a list of people requesting spaces, or request a list of space listings. The server 20 stores these space listings and requesting spaces, and sends those requesting spaces a list of spaces that meet their criteria. The server 20 also sends those with listed spaces, or simply those who request it, a list of those people requesting spaces who also meet their criteria.

Space listings can refer to any physical space that can be occupied. For example, space listings can be for a place in a line, or a parking space. Thus, some users may occupy a spot at the head of a line, or may be occupying a parking space, while other users may desire this spot in line or parking space, as it is superior to the one they could find themselves, or simply would save them time to transact for this spot/space instead of searching for their own. Any other physical space capable of identification is also contemplated.

Space listings can also encompass any information identifying a space. For example, a space listing can include any one or more of location information identifying the space by its physical location (e.g., an address, cross streets, position # in line, space #, coordinates such as GPS coordinates, etc.), time information indicating when the space is available and for how long, price (that space holder wishes to receive, that space buyer/renter wishes to pay, etc.), number of spaces available, and the like. Thus, space holders such as user B can request a new space listing, and be prompted for any of the above information, allowing user B to identify his/her space by, for example, its address and space #, its window of availability, and how much he/she wishes for the space. Similarly, user A can request available spaces by distance (any, whether selected or picked by server 20) from an address he/she enters, or by distance from their current location as determined by their mobile communications device, and/or by maximum price, whether it is available immediately, and by user rating. Space listings can also encompass a description of the space, e.g. a text-based description of the space that can convey any information in addition to the above. For instance, the text-based description may describe the condition of the space, warnings, or the like. Any and all of this information may be stored in the various databases of server 20 for retrieval and/or updating at any time.

Accordingly, listings sent to users A and B can include any of the above information. This allows users A, for example, to receive listings of nearby users who may be interested in user A's space, as well as their locations and how much they are willing to pay. Furthermore, server 20 can update the information in user A's listing in substantial real time. In this manner, server 20 presents space sellers with an effective real time view of the market for their space, with constantly updated information on the number of potential buyers and the prices they may be willing to pay.

As another example, users B may receive listings of nearby spaces they may be interested in, their locations, and how much the space owners/renters wish to receive for their spaces. Server 20 can update user B's listing in substantial real time, presenting space buyers/renters with an effective real time view of the price for the type of spaces they are interested in.

One of ordinary skill in the art will realize that embodiments of the invention also include other aspects besides those strictly described above. For example, spot buyers may contact spot sellers to buy or rent spots for any time. In particular, spot buyers may reserve a spot for whenever they arrive at the spot, or may reserve a spot immediately, regardless of when they actually arrive at the spot. As to the latter case, users may contact spot holders and reserve a spot remotely and right away. In this manner, they are guaranteed a spot when they arrive, rather than taking the risk that spots may be sold out or unavailable by the time they arrive at the spot's location. For instance, users desiring to park at a parking garage which they fear may be full by the time they arrive, may be matched with the garage and reserve a space there immediately, while they are still far from the garage. This guarantees them a spot at the garage when they actually arrive. The garage owner would charge the user for the space beginning as soon as they make their reservation, and set the space aside as being reserved for the user. In this manner, users are guaranteed a spot in a busy garage when otherwise one may not be available when they actually arrive, and spot owners/renters receive more income, as they can begin charging for their spots immediately upon booking the reservation, rather than waiting until the user actually arrives and occupies the spot. In operation of an exemplary such embodiment, sellers such as parking lot owners would enter listings via their systems 50, buyers would select one of these listings at Step 408, and contact the parking lot owner at Step 414. The buyer would then contact the parking lot owner or his representative and book a space in the lot immediately, even though the buyer is currently remote from the lot. The parking lot owner would reserve a space for the buyer, perhaps by flagging it as occupied, placing a reserved sign in a vacant space, etc. The parking lot owner would also begin charging the buyer immediately (perhaps by electronically charging an account, in known manner), even though the buyer is not yet occupying the space. Once the buyer arrives at the garage, the license plate reader 58 may determine the buyer's arrival, and the buyer may be directed to his/her reserved space. Upon departure, the buyer would be charged an amount corresponding to the time period beginning at space reservation and ending at lot departure, rather than the more common time period beginning at lot arrival and ending at lot departure. One of ordinary skill in the art will realize that this option to book spots beginning at the time of reservation rather than the time of arrival at the spot (and being charged accordingly) may be applied to any type of spot, whether it be a parking space or any other type of spot.

As another example, various embodiments can include a rating system allowing users to rate other users, as well as the spaces they buy/rent. Users are allowed to submit a review after their transaction, describing the other user they transact with. Space renters/buyers can also review the space they rent/buy. These reviews are stored by server 20 in the appropriate database as part of the space listing or associated with that user's information, as appropriate. Reviews, along with an overall ranking or rating, can then be sent as part of the listings sent to users. This allows users additional information to consider when deciding who to select from their listing. Reviews can be compiled and rated in any manner.

As another example, it can be noted that embodiments of the invention are not limited to spaces. That is, embodiments of the invention provide a platform for transacting in more than just spots or spaces. Listings need not be limited to physical spaces, but instead the information entered at Steps 304 or 512 can be information identifying any physical thing, product, or service. For instance, a listing can be created for event tickets, where the location, price, time, and number of spot information entered can correspond to the event location, ticket price, event start time, and number of tickets, respectively. In this manner, embodiments of the invention can provide a platform by which ticket sellers and buyers can find each other, and get a real time view of the market for those tickets. Indeed, it is contemplated that users can self-define any market objects, i.e. anything capable of being the subject of a transaction, whereupon the platform of the invention can allow the matching of buyers and sellers of those market objects, as well as give a real-time view of their market.

Listings can also be created for items such as available restaurant tables, or available hotel rooms. Thus, for example, restaurants can create listings for tables they may have that are unreserved, either currently or at a specified time in the future. Individuals who may currently be searching for a restaurant may request listings of nearby restaurants with available tables, and would thus be sent restaurant listings that meet their criteria. In this manner, restaurants and other businesses may be able to fill unreserved or otherwise available tables that may not have gotten filled, and individuals are saved the time and effort of manually searching for a suitable restaurant. Similarly, hotels can create listings for available unfilled rooms, and individuals searching for a nearby room may be able to conveniently obtain a listing of such rooms without having to call every nearby hotel, or physically go to a number of hotels searching for one with vacancies.

As additional examples, listings can also be created for any manner of service. For instance, the information entered at Steps 304 or 512 can be information for creating listings for any service, such as delivery/pickup of an item, desirability of/availability for performing any service such as pet walking, accompanying someone for safety purposes, desired presence at an event, etc. In the case of delivery/pickup, listings can be created by specifying information such as the delivery and/or pickup location(s), times of availability, price (of performing the delivery/pickup), and one or more identifiers of the item to be delivered/picked up (e.g., food, dry cleaning, groceries, mail, etc.). Other information may also be provided if desired, such as whether the deliverer/pickup person is to advance payment of the item and be subsequently reimbursed, or is to receive funds from the other party first. In this manner, embodiments of the invention can provide a platform by which those available to perform delivery/pickup services, and those desiring such services, can find or be matched up with each other, and get a real time view of the market and cost for such services.

One of ordinary skill in the art will recognize that such listings can be for any other service besides delivery/pickup. For example, listings can instead be made for those seeking a safety escort, such as unaccompanied females seeking another to walk with them through an area that may be dangerous. In this manner, embodiments of the invention can provide a way to match, for instance, female students seeking to walk through a university campus at night, with male students who are available to walk with them and thus provide a measure of safety and reassurance, for a price that can be viewed in substantial real-time. Listings can be made giving location, time, price, and accompaniment distance, for example, with buyers of such accompaniment services listing their location, when they would like to be accompanied, how far, and desired price, while sellers of such services can list their areas and times of availability, and desired fees. Embodiments of the invention can match/notify buyers of sellers that meet their criteria, and vice versa.

As another example, listings can be made for those seeking qualified people to attend events that require a certain qualification level, such as conferences seeking additional attendees, or attendees to fill chair/moderator positions or the like that are vacated unexpectedly at the last minute. In this manner, embodiments of the invention can provide a way of matching those seeking people with specific predetermined qualifications or credentials, with those who have such qualifications/credentials and are available to attend.

As a further example, users can restrict listings to a particular geographic region, such as a neighborhood. Embodiments of the invention can, for instance, allow users to restrict their listings only to users within a particular geographic area, or to generate lists of specific users that form a group. Only members of this particular group may see each others' listings. In this manner, for example, residents of a particular neighborhood may form their own local market for goods/services, listing their availability or their desired items/services for others in the neighborhood to see.

One of ordinary skill in the art will observe from the above that embodiments of the invention effectively provide a real-time, active matchmaking platform which matches buyers and sellers of particular spaces. More specifically, both buyers and sellers can create listings of their desired/available space, and each is sent the other's listings. This allows buyers to find sellers that they may be interested in (i.e., that meet their criteria), and vice versa. The optional display of other additional information such as price further allows both buyers and sellers to see the market for their spaces in substantial real-time, and perhaps adjust their prices or otherwise behave accordingly.

The various figures show simplified examples of hardware configurations, so as not to distract from an understanding of various aspects of the invention. It will be recognized that hardware implementing aspects and embodiments of the invention can have any other structure and/or function allowing it to implement the above described methods and solutions. For example, the various network components shown may have more than one processor and more than one connection to various networks. Additionally, the various software modules shown can exist as discrete modules as shown, or can exist as parts of a larger set of code of any kind.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, a platform is provided for matching parties to transactions in spaces, but more than just spaces may be the subject of these transactions. Anything capable of being the subject of a transaction is contemplated. Also, while the platform can at a minimum allow buyers and sellers of a thing to find each other, it can also provide further features helpful to these buyers and sellers, such as ratings of buyers, sellers, and the things that are the subject of their transactions, real time price information that provides a constantly updated market picture, and the like. The embodiments were chosen and described in order to best explain the principles of the invention and its practical applications, to thereby enable others skilled in the art to best utilize the invention and various embodiments with various modifications as are suited to the particular use contemplated. Also, individual features of any of the various embodiments described above or understood by one of ordinary skill in the art can be mixed and matched in any manner, to create further embodiments contemplated by the invention.

List of Features
Platform for connecting buyers, sellers of spaces
   Real-time, active matchmaking platform
Sellers enter space listings, buyers enter criteria explaining spaces they are looking for
   Login/account creation may be required—can include username, password, name, phone #, email, etc.
   Listings associated with specific user account
Buyers sent list of spaces that meet their criteria; sellers sent list of buyers that meet their criteria; potential sellers sent list of buyers and what they are interested in
   Updated in real time
   Price listings can give real time view of market
   Map-based, text-based, other listings
Rating system allows users to rate other users, spaces
   Listings sent to buyers/sellers can include ratings
Listings can be for anything capable of being transacted for—spaces in line, parking spaces, tickets, vacant tables at restaurants, vacant hotel rooms, etc. Listings can be for products or services, and can include any service—item delivery/pickup, accompaniment, qualified individuals for attending events, etc.
Listings can be restricted to particular users, particular geographic areas such as neighborhoods, etc.
Criteria can include location, time, price (for both buyer and seller), # spaces, text-based description, etc.
Mobile device can transmit location, automatically or otherwise; listings near that location can be sent to device
Transactions can allow reservation of spaces (or anything else) immediately, even if buyer/renter is not physically at space yet
   Buyer charged beginning at reservation time, not time of arrival at space
   Seller/renter reserves space immediately upon reservation, not upon arrival at space

What is claimed is:

1. A computer-implemented method of facilitating a transaction for a physical space, the method comprising:
specifying, in a digital computer, one or more criteria for identifying transitory physical spaces that can be occupied;
receiving, at the digital computer, information describing one or more of the spaces that satisfy the one or more criteria;
transmitting an identification of a selected space from among the described one or more spaces; and
receiving, at the digital computer, contact information associated with the selected space.

2. The method of claim 1, wherein the space is a parking space.

3. The method of claim 1, wherein the space is a position in a queue.

4. The method of claim 1, wherein the one or more criteria include at least one of a price, a date, a time, a size, a text-based description, and a number of spaces.

5. The method of claim 1, wherein the information describing one or more of the spaces further comprises price information for the one or more of the spaces.

6. The method of claim 1, wherein the one or more criteria include a location identifier, and wherein the spaces that satisfy the one or more criteria are within a predetermined distance from a location represented by the location identifier.

7. A computer-implemented method of facilitating a transaction for a physical space, the method comprising:
specifying, in a digital computer, one or more criteria for identifying parties interested in one or more transitory physical spaces that can be occupied;
receiving, at the digital computer, information describing one or more of the parties that satisfy the one or more criteria;
transmitting an identification of a selected party from among the described one or more parties; and
receiving, at the digital computer, contact information for the selected space.

8. A computer-implemented method of facilitating transactions of particular spaces, the method comprising:
receiving, from a plurality of first digital computing devices representing a plurality of first users, information describing a plurality of transitory physical spaces that can be occupied;
receiving, from the plurality of first digital computing devices, one or more first criteria by which to identify parties potentially interested in the plurality of transitory physical spaces;
receiving, from a plurality of second digital computing devices representing a plurality of second users, one or more second criteria by which to identify transitory physical spaces of interest;
transmitting to the plurality of first digital computing devices information describing those second users that meet the one or more first criteria; and
transmitting to the plurality of second digital computing devices information describing those physical spaces that meet the one or more second criteria.

9. The method of claim 8 wherein the one or more first criteria include desired prices for the plurality of transitory physical spaces, the method further comprising receiving updates to the desired prices, and transmitting to the plurality of second digital computing devices the updates to the desired prices.

10. The method of claim 8 wherein the one or more second criteria include prices the second users are willing to pay for the plurality of transitory physical spaces, the method further comprising receiving updates to the prices the second users are willing to pay, and transmitting to the plurality of first digital computing devices the updates to the prices the second users are willing to pay.

11. The method of claim 8 further comprising:
receiving, from the plurality of second digital computing devices, selections from among those physical spaces that meet the one or more second criteria; and
transmitting to the plurality of second digital computing devices contact information associated with the selections.

12. An apparatus, comprising:
a system of one or more digital computers in electronic communication with each other, the one or more digital computers programmed to provide a medium for facilitating transactions of transitory physical spaces that can be occupied, by:
allowing users to enter specified criteria defining the transitory physical spaces;
transmitting, to first ones of those users seeking one or more of the transitory physical spaces, information on those transitory physical spaces that meet their specified criteria; and
transmitting, to second ones of those users owning or occupying one or more of the transitory physical spaces, information describing the first ones of those users that meet the specified criteria of the second ones of those users.

13. A method of facilitating transactions for goods and/or services, the method comprising:
receiving, from a first set of users, first price information corresponding to prices that the first set of users are willing to pay for predetermined goods and/or services;
receiving, from a second set of users, second price information corresponding to prices that the second set of users request in return for the goods and/or services;
transmitting the second price information to the first set of users, so as to form transmitted second price information;
transmitting the first price information to the second set of users, so as to form transmitted first price information;
receiving updated ones of the first price information and the second price information from the first and second sets of users; and
updating the transmitted first and second price information in substantial real time as the updated ones of the first and second price information are received, so as to provide to both the first and the second set of users a substantially real time view of one or more market prices for the goods and/or services.
